(19) United States
(12) Patent Application Publication
(10) Pub. No.: US 2015/0288331 A1
(43) Pub. Date: Oct. 8, 2015

(54) METHOD AND DEVICE FOR MONITORING A PHOTOVOLAIC SYSTEM

(71) Applicant: ELLENBERGER & POENSGEN GMBH, Altdorf (DE)

(72) Inventors: Christian STROBL, Nuernberg (DE); Jochen SEEFRIED, Ellingen (DE); Albert GERNGROSS, Hilpoltstein (DE)

(73) Assignee: ELLENBERGER & POENSGEN GMBH, Altdorf (DE)

(21) Appl. No.: 14/742,754

(22) Filed: Jun. 18, 2015

Related U.S. Application Data
(63) Continuation of application No. PCT/EP2013/003068, filed on Oct. 11, 2013.

(30) Foreign Application Priority Data
Dec. 18, 2012 (DE) 10 2012 024 728.1

(51) Int. Cl. H02S 50/10

(52) U.S. Cl. CPC H02S 50/10

(57) ABSTRACT

A device and a method for monitoring a photovoltaic system having a number of parallel-connected strings routed towards a common connecting lead for a reverse current. In the method it is provided for a current flow to be detected in a preferred direction in each of the strings and for a first total current flow to be created therefrom, for a current flow to be detected in the preferred direction in the connecting lead and for a second total current flow to be created therefrom, and for the first total current flow to be compared with the second total current flow, wherein a reverse current is recognized if the first total current flow deviates from the second total current flow by more than a tolerance value.

This nonprovisional application is a continuation of International Application No. PCT/EP2013/003068, which was filed on Oct. 11, 2013, and which claims priority to German Patent Application No. 10 2012 024 728.1, which was filed in Germany on Dec. 18, 2012 and which are both herein incorporated by reference.

### BACKGROUND OF THE INVENTION

1. Field of the Invention

The present invention relates to a method and a device for monitoring a photovoltaic system having a number of parallel-connected strings routed towards a common connecting lead for a reverse current.

2. Description of the Background Art

A photovoltaic system (PV system), as an electrical direct current system, typically includes a plurality of strings connected in parallel to one another, which in turn each comprise a number of photovoltaic modules (PV modules) that are connected in series. Typically, an inverter is connected to the common connecting leads, towards which the individual strings are routed. This transforms the direct current that is provided by the PV modules into an alternating current for supply into a power grid. Should one or more of the PV modules be only weakly irradiated with solar energy in comparison to the others, or should individual PV modules be defective, then it is possible for a so-called reverse current to occur. In such a case, the electric current flows contrary to the current direction of when there is no defect. This can destroy individual P PV modules, or at least reduce the efficiency level of the PV system.

Patent document EP 2 282 388 A1, which corresponds to U.S. 2012/0126626, discloses a device for supplying electrical energy from a photovoltaic system into a power grid. The photovoltaic system comprises a plurality of strings having photovoltaic modules, wherein each string can be switched on and off by a circuit breaker. For this purpose, the circuit breaker is opened or closed by a motor. In the event of an overcurrent detected by a direction-sensitive current sensor assigned to the respective string, the respective string is then isolated from the power grid, as is the case with, for example, a faulty wiring.

Furthermore, each of the current sensors monitors the respective string for a reverse current; in the event thereof, the string is also isolated from the power grid. Therein, due to the design of the current sensors as direction-sensitive current sensors, it is possible to assign the current flow in the respective direction on the basis of whether a measurement is positive or negative.

Patent document DE 20 2009 004198 U1, which corresponds to U.S. Pat. No. 8,742,828, discloses a circuit breaker having a mechanical switch that is current-conducting during operation, and semiconductor electronics connected in parallel thereto, which are current-blocking when the switch is closed. If the switch is opened, an arc voltage of an electric arc generated across the switch connects the semiconductor electronics in a current-conducting manner.

Patent document U.S. 2008/0147335 A1 discloses a method for monitoring a photovoltaic system. In one embodiment therein, a current flow in each individual string of a cluster of photovoltaic modules is detected, wherein a measurement module having a current sensor is used. Also, the electrical current is measured at a connecting lead of the cluster.

The article “Ground Fault Analysis and Protection in PV Arrays” discusses reasons for short circuits in a photovoltaic system. Also, the current flow at connecting points of the photovoltaic system are determined on the basis of Kirchhoff's laws.

### SUMMARY OF THE INVENTION

It is therefore an object of the present invention to address the problem of setting forth a particularly suitable method and a particularly suitable device for monitoring an electric PV system for a reverse current, which are particularly cost-effective.

The method is used for monitoring of a PV system for a reverse current, the PV system comprises a number of strings that are connected in parallel to one another and routed towards a common connecting lead. Herein, a string can designate a current path. At least one of the strings may also be composed of or at least comprise a further number of current paths connected in parallel to one another. The system can comprise two connecting leads to which the strings are respectively electrically connected. Alternatively, the end of the string or strings facing away from the connecting lead is respectively routed to ground. Suitably, the PV system includes an inverter. The strings can each comprise a number of series-connected PV modules.

In each of the strings, a current flow is detected in a preferred direction, wherein the preferred direction therein is, in particular, rectified. In other words, the preferred directions of the individual strings are parallel to one another and are directed either to the connecting lead or away therefrom. The detected current flows has measured values that are detected via an appropriate measuring instrument. Alternatively, the current flows can be calculated from alternatively detected measured quantities. In the range of the tolerances respectively contributing to the detection, the detected current flows correspond to the electric currents actually flowing through the string.

From the detected current values, a total current flow is generated by, for example, cumulatively adding the individual detected values together. With a current flow counter to the preferred direction of the value, a value of zero is used as the current flow. In a further step, which can take place at substantially the same time, a current flow in the preferred direction in the connecting lead is detected and a second total current flow is generated therefrom, wherein the detected current flow also entails, in particular, a directly measured value. In particular, the detected current flow through the connecting lead is used for the second total current flow. Again, a current flow against the preferred direction here can correspond to a detected value of zero. In other words, the second total current flow can be equal to zero if the current flow in the connecting lead is counter to the preferred direction. All of the preferred directions can be substantially parallel to one another. In a subsequent method step, the first total current flow is compared to the second total current flow. Should the first total current flow deviate from the second total current flow by more than a tolerance value, which is, for example, zero, then a reverse current is recognized. In particular, a reverse current is present if the second total current flow is smaller than the first total current flow plus the tolerance value.

The method makes it simpler to monitor the PV system, because only the current flow in one direction is monitored. An elaborate pole reversal of the measuring instruments, which could lead to an electric arc, is forgone. Furthermore, only comparatively inexpensive measuring instruments that are capable of ascertaining only a current flow in a certain direction or that are not direction-sensitive need be used for determining the current flow.

The preferred direction can be selected, for example, so as to be counter to the respective reverse current direction, and thus is anti-parallel thereto. Consequently, the respective detected current flow does not correspond to the reverse current itself, but rather corresponds to the current in the desired current direction for which the PV system is provided and, in particular, constructed. It is thus possible, via the ascertained current flow or current flows, to determine the present performance or present efficiency level of the PV system, wherein the first or second total current flow is analyzed as a single method step.

Also, whichever string has the lowest ascertained current flow can be determined to be the carrier of the reverse current. In other words, it can be assumed that the string at which the lowest current flow is ascertained is the one being traversed by the reverse current. In particular, the deviation between the first and second total current flows minus the tolerance value can be used as the value of the reverse current flowing through the string having the lowest ascertained current flow. In this manner, the fact that a reverse current is present is not the only thing that is established. The value of the reverse current is also additionally made known, at least approximately, even if the value is subject to a defect, namely, the tolerance value. Thus, the operation of the PV system can be adapted or altered in accordance with the magnitude of the reverse current and the associated tolerance value, in particular in order to prevent further propagation of the reverse current.

In a particularly suitable embodiment, the string having the lowest ascertained current flow is isolated from the connecting lead if a reverse current has been recognized. In this manner, the string and any electrical components and/or other components of the PV system located in this current path are protected from further damage caused by the reverse current. Furthermore, a reduction in the efficiency level of the PV system is prevented.

If, after isolation of the string, there continues to be a reverse current that has since been recognized via the total current flows ascertained after the isolation of the string, then the string that then possesses the lowest current flow can be isolated from the connecting lead, such that two strings are isolated from the connecting lead. Alternatively or in combination therewith, the connecting lead can be itself severed, in order to prohibit the current flow through the connecting lead. If only the connecting lead is interrupted when a reverse current is recognized, then suppressing the reverse current takes comparatively little effort. If both the string and the connecting lead are interrupted, then the safety against a reverse current is enhanced, because a redundant current interruption is designed. Alternatively to interrupting the connecting lead, it would also be possible to interrupt all of the strings if a reverse current has been determined. A current flow through the PV system is consequently also prevented. This is provided, for example, if operation of the PV system with the number of strings having been reduced by one string is not possible or desired.

The sum of all of the prevailing failure tolerances that predominate in the detection of the current flow through the strings can be used for the formation of the tolerance value. In particular, the sum thereof forms the tolerance value. In other words, in addition to the current flow through the respective string, the respective failure tolerances predominating therein are also detected and cumulatively added up to form the tolerance value. It is thereby possible to distinguish the individual failure tolerances between the strings, and/or to use the varying failure tolerances in accordance with the magnitude of the ascertained current flow.

Alternatively or in combination therewith, the failure tolerance can be ascertained upon detection of the current flow through the connecting lead, and this value is used to form the tolerance value. The tolerance value is drawn from the total of the failure tolerances that occur upon detection of the current flow through the respective strings, plus the failure tolerance upon detection of the current flow through the connecting lead, in order to form the tolerance value, and, in particular, forms same. If the failure tolerances do not vary symmetrically around the detected value but instead are organized differently depending on the extent of upward or downward deviation, then, in order to form the tolerance value, either the total of the positive failure tolerances upon detection of the current flow through the strings plus the negative failure tolerances upon detection of the current flow through the connecting lead or the total of the negative failure tolerances upon detection of the current flow through the strings plus the positive failure tolerances upon detection of the current flow through the connecting lead can be used as the tolerance value, depending on the sign of the deviation, i.e., on whether the first total current flow is greater or smaller than the second current flow. “Negative failure tolerance” designates here the deviation that is tolerated when the respective current flow downwards is ascertained, i.e., designates by how much the detected value deviates from the actual value. In addition to the individual failure tolerances, there is, for example, another correction term that is provided in order to form the tolerance value, via which other effects are considered. Due to this manner of ascertaining the tolerance value, only actual reverse currents are recognized, and not any artifacts ascertained because of measurement accuracies. In particular, if one or every current flow is interrupted after a recognized reverse current, the reliability of the PV system is enhanced in this manner.

The device for monitoring a PV system for a reverse current can include a sensor arrangement and, in particular, a controller, via which, for example, the method is carried out. In other words, the controller can be provided and designed in order to carry out the method for monitoring the PV system for a reverse current. The PV system comprises a number of strings (current paths) that are connected in parallel to one another, and a connecting lead towards which the string, and in particular all strings, are routed.

The sensor arrangement comprises a second current sensor and a number of first current sensors, i.e., at least two current sensors, which are provided and designed in order to detect a current flow in each of the strings. One of the first current sensors can be respectively assigned to each of the strings of the PV system; also, the number of the first current sensors can be equal to the number of the strings. A current flow through the connecting lead is detected during operation of the device via the second current sensor.

The current detection takes place in the individual strings and in the connecting lead in a predetermined preferred direction. The preferred directions of the individual strings and the connecting lead can be substantially parallel to one another and rectified as well as counter to the direction of the reverse current intended to be monitored.

The number of the current sensor of the sensor arrangement can correspond to the number of the strings plus the connecting lead, which represents the most cost-effective alternative wherein all of the current flows can still be detected. The current sensors can be, for example, shunt resistors, Hall sensors, etc., which can be arranged, for example, in an air gap of a slotted toroid that is arranged around the respective current path, and thus around the connecting lead or the respective string.

The sensor arrangement makes it possible to detect not only the current flow of the strings, but also the current flow through the connecting lead. This makes it possible to make conclusions about any reverse current that may be flowing as well as to monitor the PV system for the performance thereof, without the need for the current flows of the individual strings to be cumulatively added together in order for the purpose of this determination. Rather, this value is directly available, and also has a lower failure tolerance, because the value is detected via an extra current sensor suitable therefor, and thus there is no need for the failure tolerances of the first current sensors to be added. In comparison to the use of only one current sensor monitoring the connecting lead, the use of the first current sensor also makes it possible to monitor the individual strings.

The second current sensor can be only designed and provided to detect a current flow in the preferred direction. In other words, the second current sensor is not direction-sensitive. Consequently, a relatively low-cost current sensor and/or evaluation electronics assigned thereto can be used. With an actual electric current that flows counter to the preferred direction, the detected current flow is therefore equal to zero (0).

The first current sensors are not designed so as to be direction-sensitive, so that it is possible only to detect the current flow in the preferred direction by means thereof. If all of the current sensor of the sensor arrangement are provided and designed only to detect the current flow in the respective preferred direction, then a comparatively inexpensive device can be realized.

Also, all of the first current sensor can have the same failure tolerance. Consequently, such current sensors as are subject to approximately the same failure tolerances are selected and/or provided for the first current sensors. However, the individual measurement errors of the current sensor, i.e., the actual deviation in comparison to the manufacturer's preset range of variation of the measured values (failure tolerance), may vary between the individual current sensor.

The use of current sensors that have the same failure tolerance makes it particularly easy to carry out the method, especially if the total of all of the prevailing failure tolerances of the first current sensors is used as the tolerance value or at least is used to calculate the tolerance value. The individual first current sensors can be identical to one another, resulting in reduced maintenance costs and effort.

Also, the failure tolerance of the second current sensor can be equal to the failure tolerance of the first current sensors. The second current sensor can be identical to the first current sensors. Consequently, the sensor arrangement includes only one type of current sensors, which are divided into the first current sensors and the second current sensor. This simplifies inventory of the current sensors and reduces the maintenance costs and effort. Additionally, the calculation of the tolerance value is particularly simplified if the tolerance value is calculated from the total of the failure tolerances for detection of the current flow through the connecting lead and the strings, and if only one current sensor is used per string. The tolerance value is, in this case, equal to the product of the prevailing failure tolerance of the current sensor type multiplied by the number of strings plus one.

For example, the device comprises an interruption unit, via which the connecting lead can be isolated, or via which at least one electric current through the connecting lead is interrupted in the event of a reverse current. It also becomes possible to disable the PV system via the interruption unit in the event of an overcurrent or overload of the PV system.

The device can comprise at least one interruption unit for interrupting an electric current through one of the strings. A number of interruption units corresponding to the number of strings can be a component of the device, wherein each one of the strings can be isolated from the connecting lead via the respective interruption unit, or at least one electric current through the respective string can be prohibited via at least one of the interruption units.

The interruption unit(s) can be a part of the current sensors or at least indirectly electrically contacted therewith, so that the current sensors provided with the interruption unit are modularly replaceable in the event of damage thereto.

The interruption unit can comprise a mechanical switch that is closed and thus energized in the non-triggered state of the interruption unit, i.e., if a current flow through the interruption unit is possible. The mechanical switch, which, for example, can be spring-loaded, can be bridged by semiconductor electronics. The semiconductor electronics can comprise an electrical switch, for example, a transistor or an IGBT. Furthermore, the semiconductor electronics can comprise a control input which is connected, for example, to the mechanical switch. When the mechanical switch opens, i.e., upon interruption of the current flow through the interruption unit, the semiconductor electronics are switched so as to conduct current due to an electric arch that forms in the area of the mechanical switch. For this purpose, the semiconductor electronics can comprise an energy storage device that is charged as a result of the electric arc within the duration of the electric arc, the semiconductor electronics being operated by means thereof.

Due to the electrical conductivity of the semiconductor circuit in the event of an electric arc, a current path that is low-resistance comparatively to the electric arc is connected in parallel to the electric arc, resulting in comparatively early extinction of the electric arc and thus comparatively low loading of the interruption unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically illustrates a photovoltaic system having five strings and current sensors that are parallel-connected between two connecting leads;

FIG. 2 is a flow chart illustrating a method for monitoring the photovoltaic system for a reverse current; and

FIG. 3 illustrates one of the current sensors, with an interruption unit.

### DETAILED DESCRIPTION

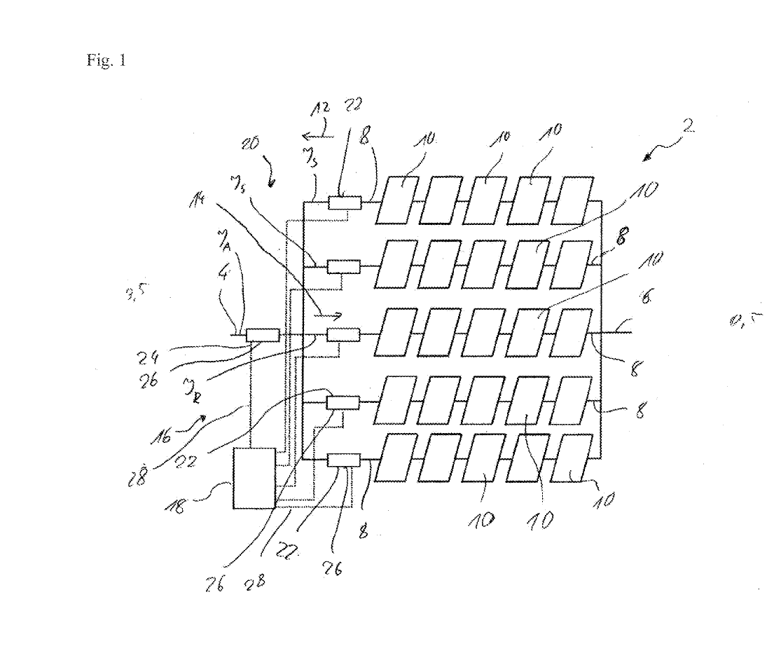

FIG. 1 is a schematic representation of a photovoltaic system (PV system) 2 having five strings 8 connected in parallel between a first connecting lead 4 and a second connecting lead 6. In other words, each of the strings 8 is routed towards the first connecting lead 4 on one side and towards the connecting lead 6 on the opposite side, and is contacted with them. The two connecting leads 4, 6 are, in turn, electrically connected to an inverter in order to supply electric power generated by the PV system 2 to a power grid. Each of the strings 8 comprises five photovoltaic modules (PV modules) 10, which are in turn connected in series in the respective string 8. A direct current is provided by the PV modules 10 when there is solar irradiation. In other words, during operation of the PV system 2, an electrical current flows in each of the strings in a preferred direction 12, and these are cumulatively added up to an electrical current through the connecting leads 4, 6.

A device 16 comprising a control unit 18 and a sensor arrangement 20 is provided in order to monitor the PV system 2 for a reverse current I_{R} counter to the preferred direction 12 in a reverse current direction 14, which occurs by way of example in the third string 8 and can lead to destruction of the PV modules 10 or at least to degradation of the efficiency level of the PV system 2. The sensor arrangement 20 in turn comprises five first current sensors 22, each one of which is respectively assigned to one of the strings 8 and via which a current flow I_{S} through the respective string 8 in the preferred direction 12 is detected. A second current sensor 24 is additionally a part of the sensor arrangement 20, the second current sensor 24 being assigned to the first connecting lead 4. A current flow I_{A} through the connecting lead 4 in the preferred direction 12 is detected by the second current sensor 24.

The current sensors 22, 24 are identical in structure, such that all measured values taken therewith are subject to the same spring tolerance. This is, for example, 0.05 amperes (A) and is symmetrical about the respective measured value, i.e., the respective detected current flow I_{S}, I_{A}. The measured values can be ascertained exclusively in the preferred direction 12 by the current sensors 22, 24. The value detected by the current sensors 22, 24 is consequently equal to zero (0) if there is an actual electric current in the reverse current direction 14, i.e., when there is a reverse current I_{R}.

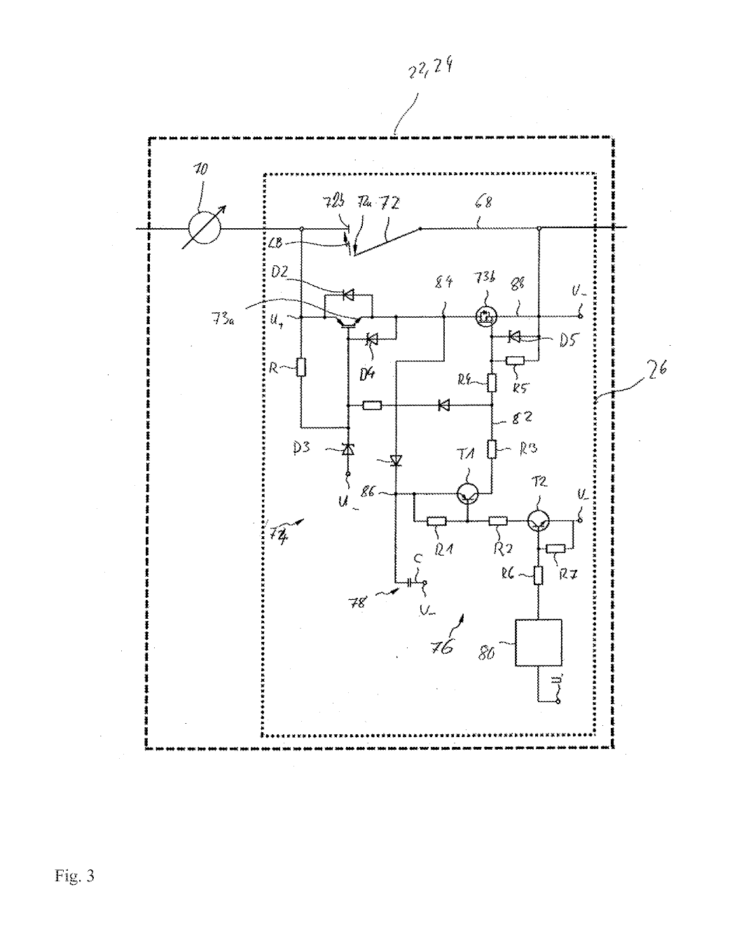

Each of the current sensors 22, 24 further comprises an interruption unit 26 (FIG. 3), and is connected to the control unit 18 via a line 28. The current flows I_{S}, I_{A} detected by the current sensors 22, 24 are transmitted to the control unit 18 via the lines 28, and control signals are applied to the respective interruption units 26 from the control unit 18 by the lines 28. Should an overload occur, or a disconnection of the PV system 2 be provided, then the first connecting lead 4 and/or the strings 8 are disconnected by the interruption units 26 of the respective current sensors 22, controlled by the control unit 18 via the lines 28, and the respective actually flowing electric current is interrupted.

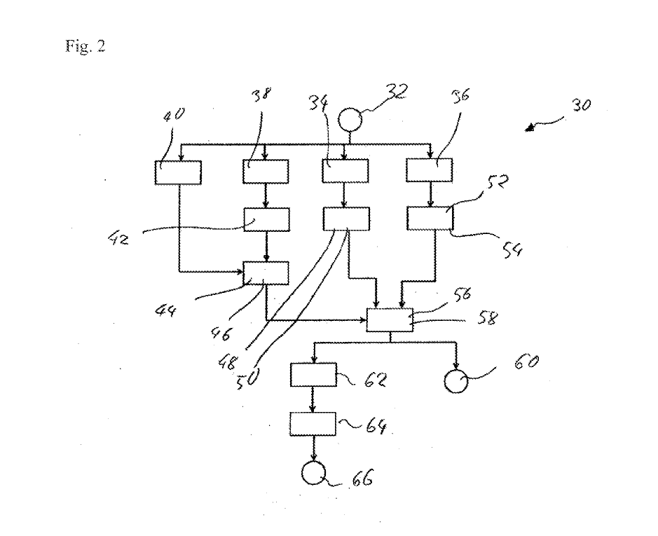

FIG. 2 is a flow chart schematically representing a method 30 for operating the device 16. After a start event 32 that occurs, for example, every 2 seconds, the current flow I_{S} in each of the strings 8 is detected by the first current sensors 22 in a first detection step 34. In proper operation of the PV system 2 and certain irradiation conditions, this will be equal to 1 ampere (1 A) per string 8. In the third string 8, however, the reverse current I_{R} in the reverse current direction 14 occurs because of a failure in one of the PV modules 10; this reverse current I_{R} cannot be detected by the first current sensor 22 assigned to the third string 8. The value transmitted to the controller 18, which executes the method 30, will instead be 0 A, although the amperage of the reverse current I_{R}=0.5 amperes.

In a second detection step 36, which takes place substantially at the same time as the first detection step 34, the current flow I_{A} in the first connecting lead 4—which is 3.5 A—is detected by the second current sensor 24. In a third and fourth detection step 38, 40, failure tolerances of the current sensors 22, 24 that prevail when the respective current flows I_{S}, I_{A} through the strings 8 or the first connecting lead 4 are detected are ascertained. These each amount to 0.05 A, due to the design of the current sensors 22, 24. In a first combination step 42, the failure tolerances of the first current sensors 22 are cumulatively added up. The failure tolerance of all of the first current sensors 22 is thus equal to 0.25 A. In a second combination step 46, this value is added to the failure tolerance of the second current sensor 24, thus forming a tolerance value 46 that consequently amounts to 0.3 A.

In a third combination step 48, all of the current flows I_{S} assigned to the individual strings 8, which were ascertained in the first detection step 34, are cumulatively added up to thereby generate a first total current flow 50. The first total current flow 50 accordingly amounts to 4 A. Furthermore, the value that was detected by the second current sensor 24 for the current flow I_{A} through the first connecting lead 4 is used as a second total current flow 54 in a fourth combination step 52. The second total current flow 54 accordingly amounts to 3.5 A. In a comparison step 56, a deviation 58 of the two total current flows from one another is generated. The amount of difference between the two is used here as the deviation 58. In other words, the deviation 58 is equal to 0.5 A. The deviation 58 is compared with the tolerance value 46, which is 0.3 A. If the deviation 58 is lower than the tolerance value 46, the method 30 terminates in a first end event 60.

Should the deviation 58 be greater than the tolerance value 46, then, on the one hand, the string 8 that carries the reverse current I_{R} is determined in a determination step 62. This is the third string, which has the lowest value for the detected current flow I_{S} in the preferred direction 12, namely, zero (0). The difference between the two, i.e., 0.2 A is furthermore used as the value for the reverse current I_{R}. In an interruption step 64, the third string 8 is isolated from the first connecting lead 4 by the interruption unit 26 of the first current sensor 22 thereof, whereby the reverse current I_{R} is interrupted. Consequently, the current flow through the first connecting lead 4 rises from 3.5 A to 4 A. After the third string 8 has been isolated from the first connecting lead 4, there occurs a second end event 66, and the method 30 is terminated.

FIG. 3 illustrates a comparatively detailed circuit diagram of one of the structurally identical current sensors 22, 24, with the interruption unit 26. The current sensor 22, 24 comprises a main current path 68 having a measurement sensor 70 that is connected into the main current path 68 and that detects the current flow I_{S}, I_{A} in the preferred direction 12. The main current path 68 routes through the interruption unit 26, which comprises a switch contact 72 (also designated hereinafter as a mechanical switch) as well as semiconductor electronics 74 connected in parallel therewith. The mechanical switch 72 and the semiconductor electronics 74 form a self-sufficient hybrid isolator switch.

The semiconductor electronics 74 comprise substantially two semiconductor switches 73a, 73b, which are connected in parallel with the mechanical switch 72, as well as a control circuit 76 having an energy storage device 78 and a timer 80. The control circuit 76 is connected to the main current path 68, via a resistor or a resistor series R. The gate of an IGBT, that can be employed as the semiconductor switches 73a, 73b, forms the control input 82 of the semiconductor circuit 74. This control input 82 is routed to the main current path 68 via the control circuit 76.

The first semiconductor switch (IGBT) 73a is connected in series in a cascade arrangement with the second semiconductor switch 73b in the form of a MOSFET. The potential U₊ sitting at the first semiconductor switch 73a is always greater than the potential U₋ on the opposite switch side, at which the second semiconductor switch (MOSFET) 73b is routed to the main circuit 6. The positive potential U₊ is 0 V if the mechanical switch 72 is closed.

The first semiconductor switch (IGBT) 73a is wired to a flyback diode D2. A first Zener diode D3 is connected on the anode side towards the potential U₋ and on the cathode side to the gate (control input 82) of the first semiconductor switch (IGBT) 73a. Another Zener diode D4 is connected on the cathode side in turn to the gate (control input 82) and on the anode side to the emitter of the first semiconductor switch (IGBT) 73a.

A diode D1 is routed on the anode side to a center or cascode tap 84 between the first and second semiconductor switches 73a, 73b of the cascode arrangement, the diode D1 being connected to the potential U₋ on the cathode side via a capacitor C serving as the energy storage device 78. It would also be possible for the energy storage device 78 to be formed by a plurality of capacitors C. Over an anode-side voltage tap 86 between the diode D1 and the energy storage device 78 or the capacitor C, a transistor T1 wired to ohmic resistors R1 and R2 is connected via additional resistors R3 and R4 to the gate of the second semiconductor switch (MOSFET) 82, which is in turn routed to the control input 82 of the semiconductor electronics 74. Another Zener diode D5 having a parallel resistor R5 is connected on the cathode side to the gate and on the anode side to the emitter of the second semiconductor switch (MOSFET) 73b.

On the base side, the transistor T1 is controlled via a transistor T2, which is connected in turn on the base side via an ohmic resistor R6 to the timer 80, implemented by way of example as a monoflop. On the base-emitter side, the transistor T2 is also connected to another resistor R7.

When the mechanical switch 72 is closed, the main current path 68 is low-resistance, whereas the parallel commutation path 88 of the hybrid isolator switches 72, 74, formed by the semiconductor switches 73a, 73b, is high-resistance and therefore current-blocking. Prior to the opening of the mechanical switch 72, the electrical voltage accumulating there is practically 0 V, and rises dramatically with the opening of the switch contacts 72a, 72b of the mechanical switch 72 to a value that is characteristic of an electric arc LB, with a typical arc voltage U_{LB} of, for example, 20 to 30 V. The positive potential U₊ therefore goes against this arc voltage U_{LB}˜30V if the mechanical switch 72 opens.

During the period of time (an arc time interval) following the contact opening time point, there has already started to be commutation of the switch current Iₛ, I_{A}, I_{R}, which substantially corresponds to the arc current, from the main current path 68 to the commutation path 88.

During the arc time interval, the arc current Iₛ, I_{A}, I_{R} is virtually divided between the main current path 68—i.e., via the mechanical switch 72—and the commutation path 88—i.e., the semiconductor electronics 74. During this arc time interval, the energy storage device 78 is charged. The period of time is then set such that on the one hand, sufficient power for a reliable actuation of the semiconductor electronics 74 is available, in particular for disconnection thereof during a time period following the arc time interval. On the other hand, the arc time interval is sufficiently short to avoid an undesirable contact erosion or wear of the switch 72 or the switch contacts 72a, 72b.

With the beginning of the electric arc LB and therewith the emergence of the arc voltage, the first semiconductor switch (IGBT) 73a is activated via the resistor R at least to the extent that a sufficient charging voltage and a sufficient arc or charge current for the capacitors C and thus for the energy storage device 78 are available. A control circuit of the electronics 74 can be created for this purpose, with the corresponding wiring of the first semiconductor switch (IGBT) 73a having the resistor R and the Zener diode D3; with the control circuit, the voltage at the cascode tap 84 is set to, for example, U_{Ab}=12 V (DC). Here, a fraction of the arc current and therefore of the switch current I_{S}, I_{A}, I_{R} of the hybrid isolator switch 72, 74 flows through the first semiconductor switch (IGBT) 73a, which is close to the positive potential U₊.

The resulting tap voltage serves to supply the control circuit 76 of the electronics 74, which is formed substantially by the transistors T1 and T2 as well as the timer 80 and the energy storage device 78. The diode D1, connected on the anode side to the cascode tap 84 and on the cathode side to the capacitor C, prevents a reverse flow of the charge current from the capacitors C and via the commutation path 88 in the direction of the potential U₋. If enough power is contained in the capacitor C and thus in the energy storage device 78, and if consequently a sufficiently high control or switching voltage at the voltage tap 86 is present, then the transistor T1 and consequently the transistor T2 activate so as to also completely activate the two semiconductor switches 73a, 73b. The arc current or switch current I_{S}, I_{A}, I_{R} flows practically exclusively through the commutation path 88 due to the resistance of the now-activated semiconductor switches, which is much lower than the very high resistance of the isolation gap of the main current path 68 formed by the opened switch 72. The positive potential U₊ thus returns to 0 V if the switch current I_{S}, I_{A}, I_{R} commutes to the electronics 74. As a result, the electric arc LB between the contacts 72a, 72b of the mechanical switch 72 is extinguished.

The charge capacity and thus the stored energy contained in the capacitor C is measured so that the semiconductor electronics 74 carry the switch current I_{S}, I_{A}, I_{R} for a period of time predetermined by the timer 80. This period of time can be set to, for example, 3 ms. The calculation of this period of time (and thus the determination of the timer 80) is essentially determined by the application-specific or typical duration for a complete extinction of the electric arc LB, as well as by a sufficient cooling of the plasma thus formed. A significant qualification here is that no new electric arc LB can arise after the disconnection of the electronics 74 with the consequently in turn high-resistance commutation path 88 and accordingly current-blocking semiconductor electronics 74 at the still-open mechanical switch 72 or via the switch contacts 72a, 72b thereof.

After the delay of the duration determined by the timer 80, the switch current I_{S}, I_{A}, I_{R} drops to practically zero (I_{S}, I_{A}, I_{R}=0 A), while at the same time, the switch voltage rises to the operating voltage provided from the strings 8. The positive potential U₊ thus goes against this operating voltage if the commutation path 88 is high-resistance due to the blocking of the semiconductor switches 73a, 73b and thus the electronics 74 are again current-blocking.

If a direct current (DC) system has at least two current paths that are routed to one another and towards a common potential point, then the method could also be advantageously applied to such an electrical system.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for monitoring a photovoltaic system comprising:
a common connecting lead; and
a plurality of parallel-connected strings routed towards a common connecting lead for a reverse current,
wherein a current flow in a preferred direction in each of the strings is detected, and a first total current flow is created therefrom, a value zero being used for the current flow when there is a current flow counter to the preferred direction,
wherein a current flow in the preferred direction in the connecting lead is detected, and a second total current flow is created therefrom, the value zero being used for the current flow when there is a current flow counter to the preferred direction,
wherein the first total current flow is compared with the second total current flow, and
a reverse current is recognized when there is a deviation of the first total current flow from the second total current flow by more than a tolerance value.

2. The method according to claim 1, wherein the preferred direction is selected so as to be counter to the respective reverse current direction.

3. The method according to claim 1, wherein a string having a lowest ascertained current flow is determined to be a carrier of the reverse current and wherein a deviation minus the tolerance value is used as a value of the reverse current.

4. The method according to claim 1, wherein, when a reverse current is recognized, a string having a lowest ascertained current flow is isolated from the connecting lead and/or the connecting lead itself is isolated.

5. A device for monitoring a photovoltaic system comprising a plurality of parallel-connected strings routed towards a common connecting lead for a reverse current to execute the method according to claim 1, the device comprising a sensor arrangement that comprises:
a plurality of first current sensors corresponding to the number of strings; and
a second current sensor for detecting a current flow through each string or through the connecting lead, respectively, in a preferred direction,
wherein the current sensors are provided and designed only to measure in the preferred direction.

6. The device according to claim 5, further comprising an interruption unit for interrupting the current flow through at least one of the strings and/or through the connecting lead.

7. The device according to claim 6, wherein the interruption unit comprises a current-carrying mechanical switch and semiconductor electronics connected in parallel thereto, which are current-blocking when the switch is closed and which comprise a control input that is connected to the switch such that when the switch opens, an arc voltage generated due to an electric arc across the switch connects the semiconductor electronics in a current-conducting manner.
